(19) United States
(12) Patent Application Publication
(10) Pub. No.: US 2006/0218827 A1
(43) Pub. Date: Oct. 5, 2006

(54) Motorized wall mount

(75) Inventor: Sheng-Chien Wang, Shenkang Hsiang (TW)

Correspondence Address: DELLETT & WALTERS, P. O. BOX 82788, PORTLAND, OR, 97282-0788, US

(73) Assignee: GEMMY INDUSTRIES CORPORATION

(21) Appl. No.: 11/096,145

(22) Filed: Mar. 30, 2005

(51) Int. Cl. G09F 19/08

(52) U.S. Cl. 40/414

(57) ABSTRACT

A motorized wall mount includes a base seat for secure engagement with a wall surface, an enclosure movably connected to the base seat so that a distance between the enclosure between the base seat and the enclosure is adjustable, a hollow head casing spaced apart from and connected to the enclosure via loops therebetween and resilient elements, an elastic support extending from the base seat to connect to a first pivot plate which is pivotally connected to a second pivot plate, the second pivot plate being securely received in the hollow head casing such that the hollow head casing is able to pivot relative to the enclosure and a power supply device operably connected to the enclosure and the hollow head casing to drive the hollow head casing to pivot relative to the enclosure.

### BACKGROUND OF THE INVENTION

1. Field of the Invention

The present invention relates to a wall mount, and more particularly to a motorized wall mount.

2. Description of Related Art

Decorations, especially wall mounts, have been popular for decades throughout the world. Some are used only for ornamental purpose only and some are used for different purposes such as anatomy, exhibition or the like. These kinds of wall mounts, once mounted on the wall, are totally static so that when people become used to them in their surroundings, people lose interest in them.

In order to re-attract people's attention, a motorized wall mount is introduced to the market. This kind of wall mount provides a single movement effect via a motor, which does increase its attraction. However, as with the immovable wall mount, the single-movement wall mount can not attract people's attention for long because interest is quickly lost in such a dull and mono-movement object.

To overcome the shortcomings, the present invention tends to provide an improved motorized wall mount to mitigate the aforementioned problems.

### SUMMARY OF THE INVENTION

The primary objective of the present invention is to provide a motorized wall mount enabling to demonstrate various movement modes so as to increase its attraction.

In one aspect of the present invention, the motorized wall mount has a first power assembly to enable the wall mount to move back and forth in a first direction.

In yet another aspect of the present invention, the motorized wall mount of the present invention has a second power assembly to enable the wall mount to move back and forth in a second direction perpendicular to the first direction.

A further aspect of the present invention is that a third power assembly is provided to enable the mouth of the wall mount to open and close.

Still a further aspect of the present invention is that a fourth power assembly is provide to enable the ears of the wall mount to move.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the motorized wall mount of the present invention;

FIG. 1A is a perspective view showing the formation of the neck of the wall mount of the present invention;

FIG. 2 is a side plan view of the motorized wall mount in FIG. 1;

FIG. 3 is a perspective view of a first power assembly;

FIG. 4 is a side plan view showing that the head movement of the motorized mount is caused by the first power assembly;

FIG. 5 is a front plan view showing the position of the second power assembly in the motorized wall mount;

FIG. 6 is a perspective view of the second power assembly;

FIGS. 7 and 8 are schematic side plan views showing lateral movement of the head of the motorized wall mount;

FIG. 9 is a schematic side plan view showing the position of the third power assembly;

FIG. 10 is a perspective view of the third power assembly;

FIG. 11 is a schematic view showing that the mouth of the motorized wall mount is moved by the third power assembly;

FIG. 12 is a schematic view showing the position of the fourth power assembly;

FIG. 13 is a perspective view showing the fourth power assembly;

FIG. 14 is a schematic view showing that ears of the motorized wall mount are moved by the fourth power assembly;

FIGS. 15 and 16 are perspective views showing an adjustment bolt is provided to adjust distance between the decoration and the base seat; and

FIG. 16A is a schematic side plan view showing that a cover is provided to the decoration as a skin.

### DETAILED DESCRIPTION OF THE PREFERRED EMBODIMENT

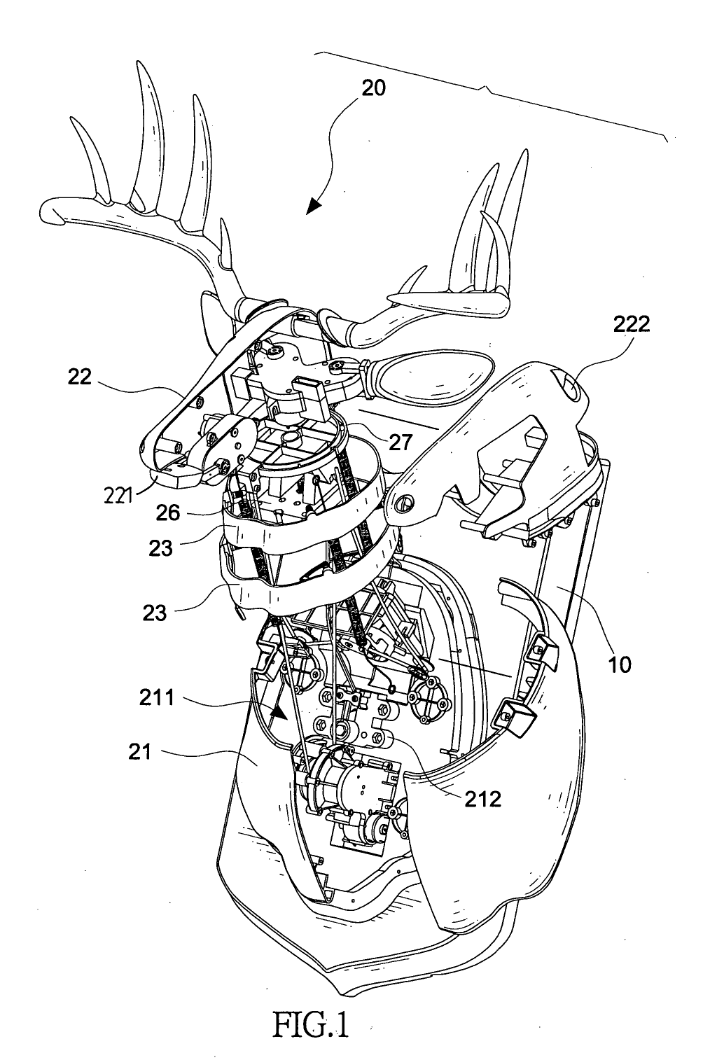

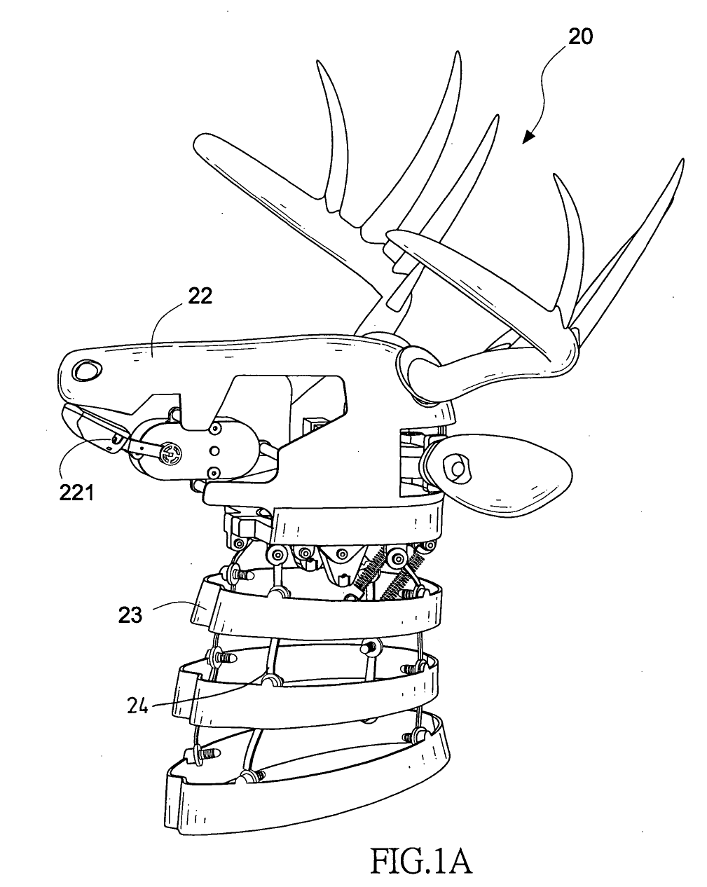

With reference to FIGS. 1 and 1A, it is noted that the motorized wall mount in accordance with the present invention basically includes a base seat (10) for secure connection to a wall surface and a decoration (20).

The decoration (20) may be an animal head in the form of a deer, a lion, a cow etc. and may include a mouth and two ears. In this preferred embodiment, the decoration (20) is a deer head portion. The decoration (20) is composed of an enclosure (21) securely connected to the base seat (10) and a hollow head casing (22) spatially apart from the enclosure (21). Multiple loops (23) are provided between the enclosure (21) and the hollow head casing (22) and connected to each other via resilient elements (24) such as cords so as to form a neck between the enclosure (21) and the hollow head casing (22).

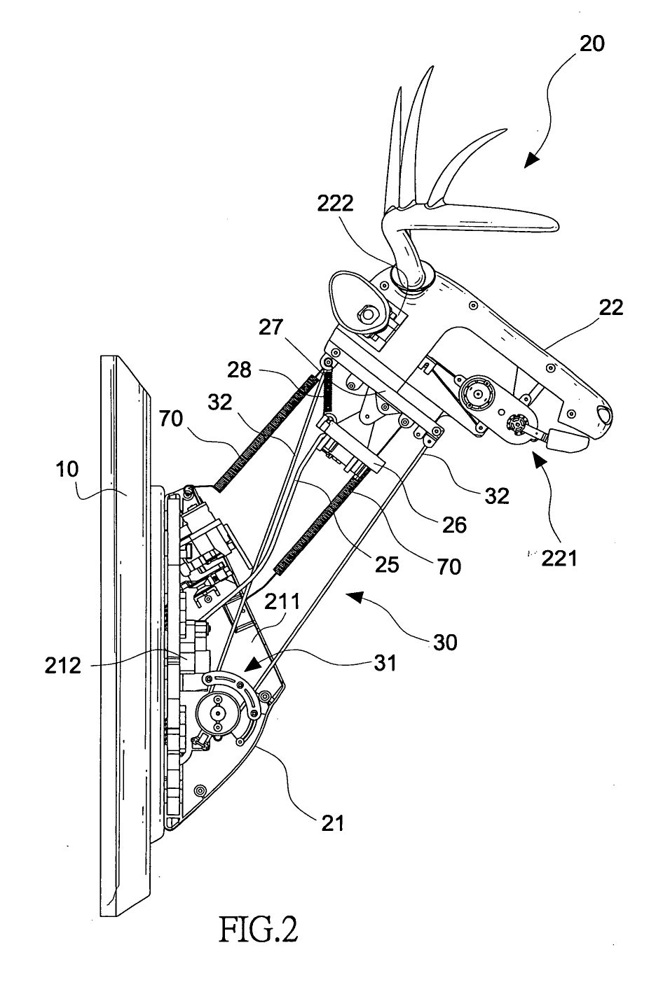

With reference to FIG. 2, the enclosure (21) has a first opening (211) defined in a front portion of the enclosure (21), a fixed seat (212) formed on a face of the base seat (10) in the opening (211) and an elastic support (25) having a first end securely connected to the fixed seat (212) and a second end extending out therefrom to connect to a first pivot plate (26) which is securely and pivotally connected to a second pivot plate (27). The second pivot plate (27) is then firmly connected to the head casing (22) such that the head casing (22) is able to pivot relative to the enclosure (21) via the pivotal connection between the first pivot plate (26) and the second pivot plate (27). Further, the head casing (22) has a second opening (221) which functions as a mouth for the head casing (22) and two apertures (222) respectively defined in two opposed sides of the head casing (22).

A power assembly may be installed inside the decoration (20) to drive the head casing (22) to move relative to the enclosure (21). Referring to FIG. 2, it is noted that a first power assembly (30) is mounted on a bottom face of the enclosure (21) and includes a first driving element (31) and at least one cord (32). The first power element (31) is mounted on the bottom face of the enclosure (21) and the at least one cord (32) is extended out from the first driving element (31) to securely connect to a bottom portion of the head casing (22). The quantity of the at least one cord (32) embodied in this preferred embodiment is actually two, i.e. one cord is connected to a front part of the bottom face of the head casing (22) and the other cord is connected to a rear part of the bottom face of the head casing (22).

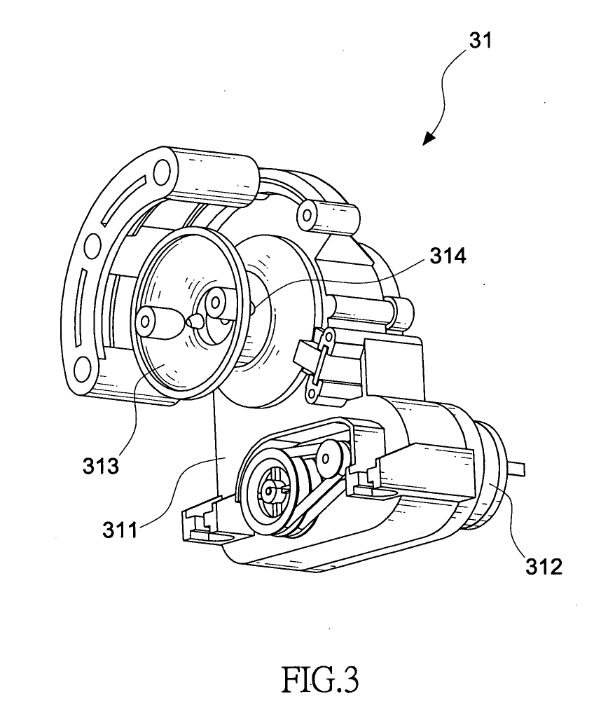

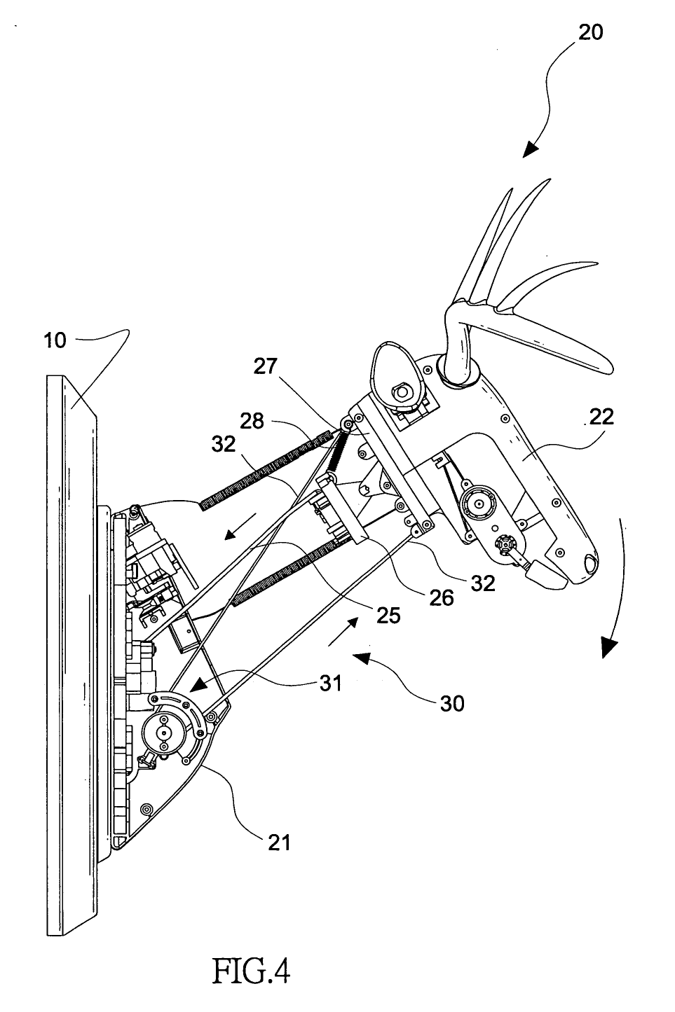

With reference to FIG. 3, it is noted that the first driving element (31) is composed of a gear box (311) having therein a reduced gear set (not shown), a motor (312) mounted outside the gear box (311) and connected to an input end of the reduced gear set, and a reeling wheel (313) mounted outside the gear box (311) and having at least one positioning hole (314) defined therein to correspond to the at least one cord (32). In this embodiment, the quantity of the at least one positioning hole (314) is the same as the quantity of the cord (32). That is, there are two positioning holes (314) defined in the reeling wheel (313) so that two first ends of the two cords (32) are respectively and securely received in the two positioning holes (314) and two second ends of the two cords (32) are respectively connected to the front portion and rear portion of the bottom face of the head casing (22). Thereafter, with the activation of the motor (312) and the alternative driving of the two cords (32) by the motor (312) via the reeling wheel (313), the head casing (22) is able to present a nodding effect, as shown in FIG. 4. Further, at least one spring (28) may be provided between the first pivot plate (26) and the second pivot plate (27) such that when the head casing (22) is pivoted due to the driving of the motor (312), the at least one spring (28) is able to provide a recovery force to return the head casing (22) to its original position.

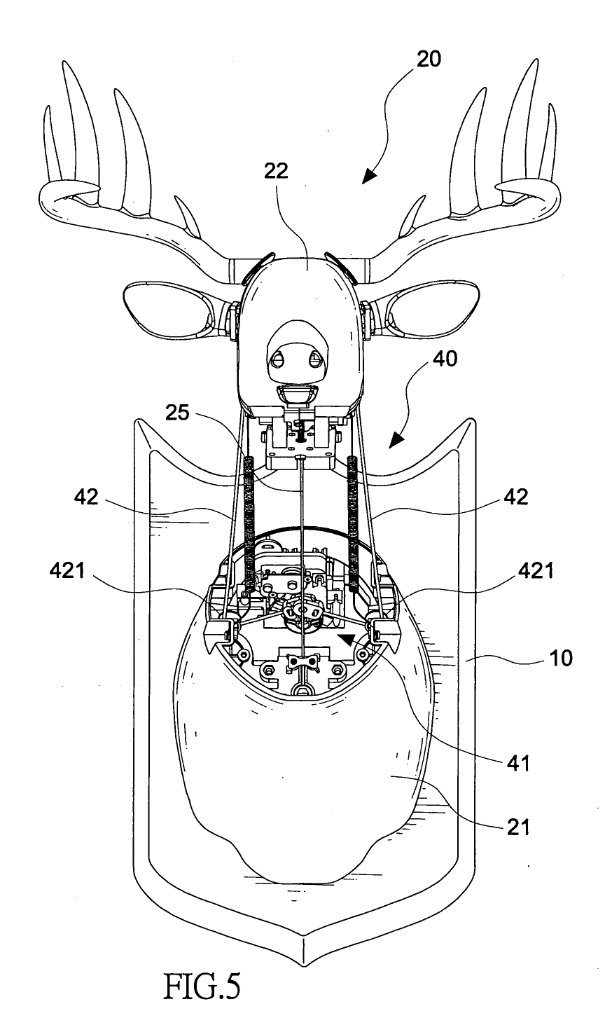

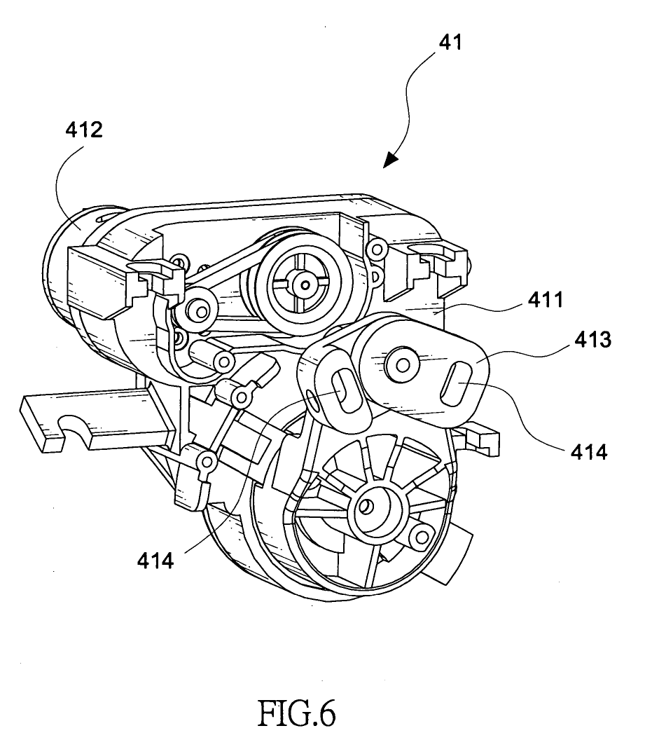

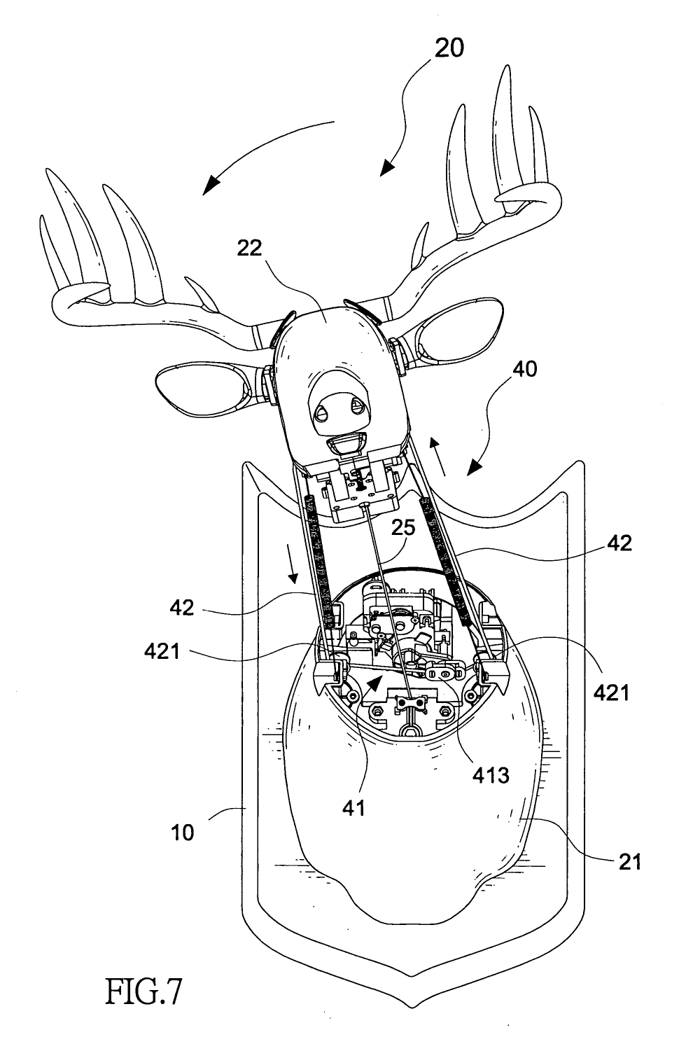

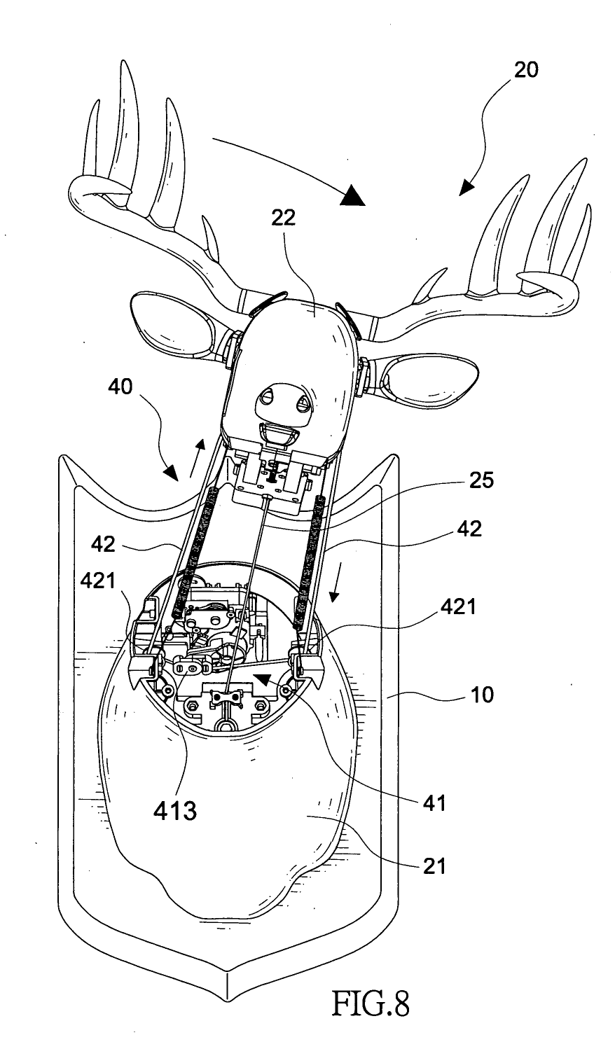

With reference to FIGS. 5 and 6, a second power assembly (40) is mounted on top of the base seat (10) and above the first power assembly (30). The second power assembly (40) is composed of a second driving element (41) and at least one second cord (42), preferably two. The second driving element (41) includes a second gear box (411) having therein a reduced gear set, a second motor (412) mounted outside the gear box (411) and connected to an input end of the reduced gear set, and a second reeling wheel (413) mounted outside the gear box (411) and having at least one second positioning hole (414) defined in the second reeling wheel (413). The quantity of the second positioning hole (414) is the same as the quantity of the second cord (42). That is, there are two second positioning holes (414) defined in the second reeling wheel (413) to respectively receive therein first ends of the two second cords (42) which respectively extend and connect to opposed sides of the head casing (22) such that when the second motor (412) is activated to alternatively drive the two second cords (42) via the second reeling wheel (413), the head casing (22) is able to rock side to side, as shown in FIGS. 7 and 8. Further, multiple second springs (70) are provided between the enclosure (21) and the head casing (22) to facilitate the nodding and rocking effect of the decoration (20). Furthermore, two pulleys (421) are respectively provided on two opposed sides of the head casing (22) to have the two second cords (42) to pass so as to smoothen the movement of the two second cords (42).

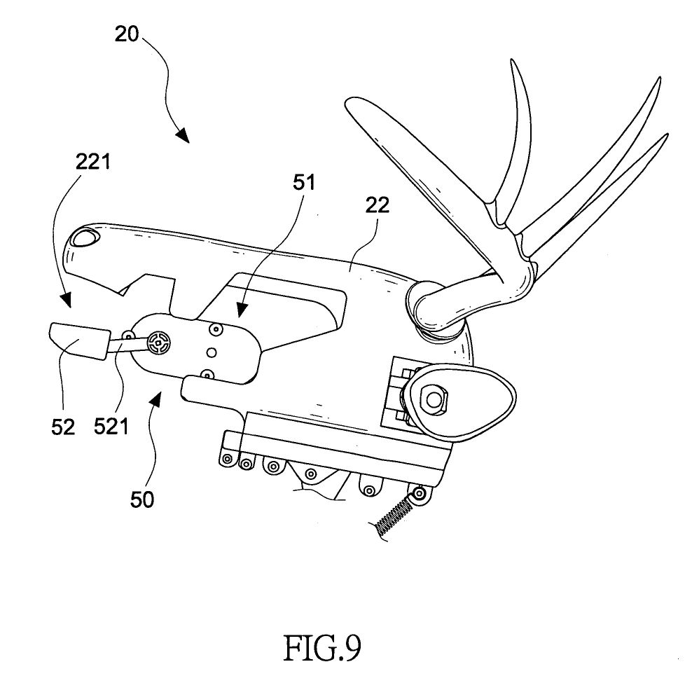

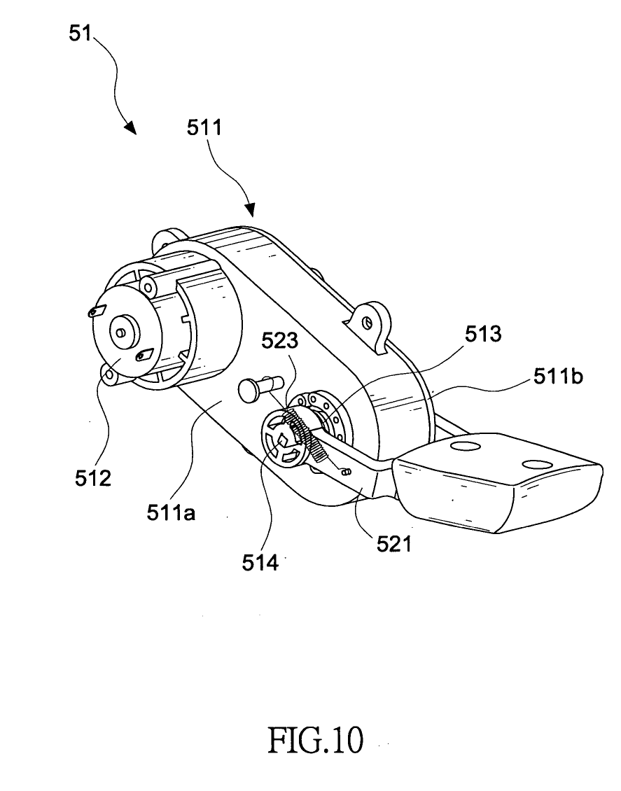

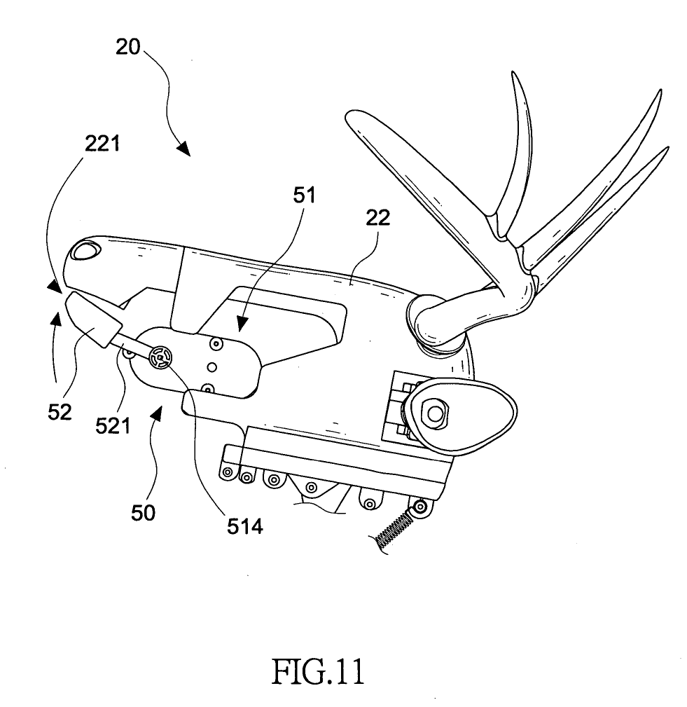

With reference to FIG. 9, a third power assembly (50) is mounted on a bottom face defining the second opening (221) of the head casing (22). The third power assembly (50) includes a third driving element (51) and a moving plate (52) operably connected to the third driving element (51) via a linkage (521) so that the moving plate (52) is controlled by the third driving element (51) to move. The third driving element (51) is provided with, as shown in FIG. 10, a third gear box (511) which is composed of a first half (511a) having a through hole (513) and a second half (511b), a third motor (512) mounted outside the third gear box (511) and connected to a reduced gear set received in the third gear box (511) and an axle (514) extending out of the through hole (513) to connect to the linkage (521). When the third motor (512) is activated to drive the linkage (521) to move, the movement of the moving plate (52) is able to present an image in that the second opening (221) (the mouth) is able to continuously open and close, as shown in FIG. 11. Further, a torsion spring (523) provided between an outer face of the third gear box (511) and the linkage (521) is able to provide a recovery force to the moving plate (52) after being moved so that when the moving plate (52) is moved to present a mouth closing effect, the torsion spring (523) is able to provide a recovery force to return the moving plate (52) to its original position.

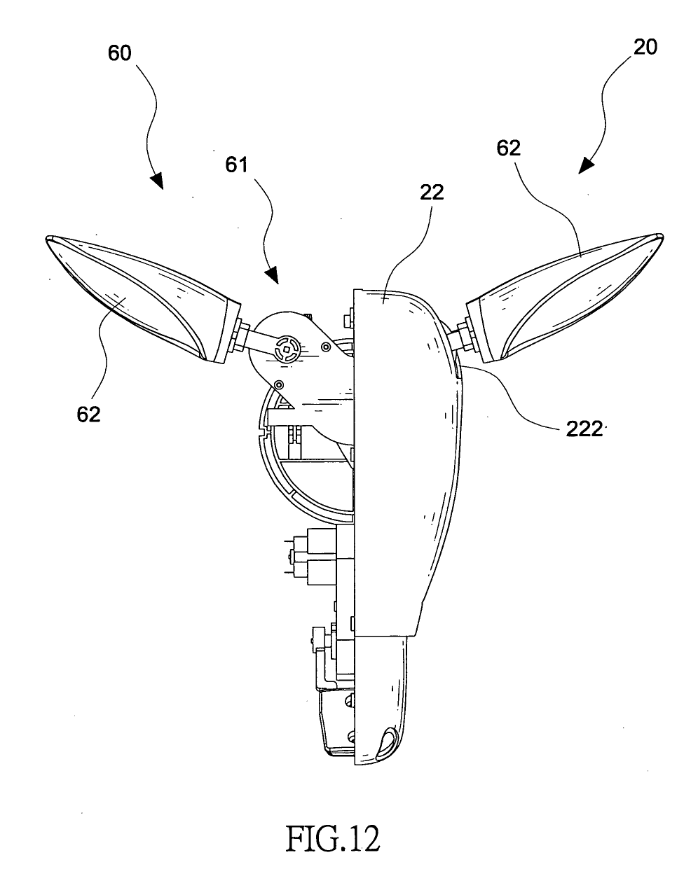

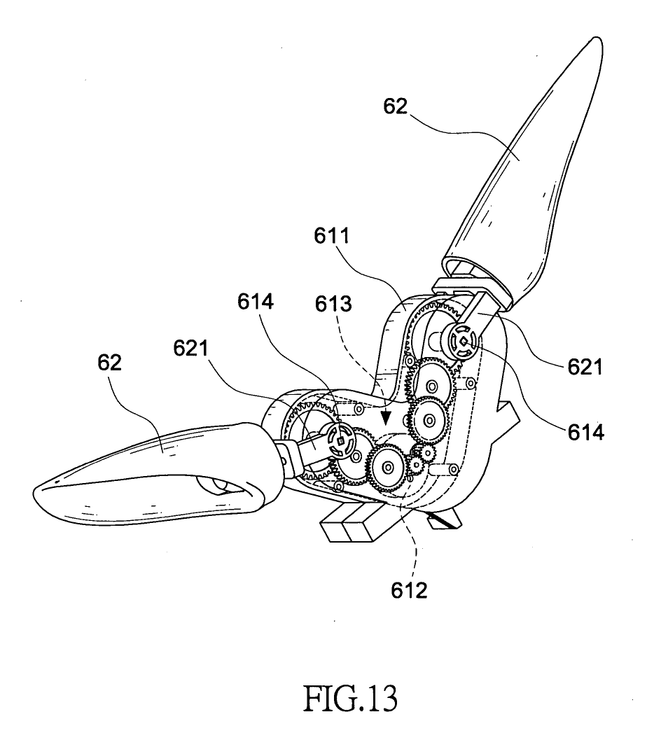

With reference to FIG. 12, a fourth power assembly (60) is mounted on the bottom face of the head casing (22) to be substantially parallel to the third power assembly (50). The fourth power assembly (60) is composed of a fourth driving element (61) mounted on a rear portion of the head casing (22) and a pair of ear-like plates (62) respectively positioned at a corresponding one of the two apertures (222) of the head casing (22) to function as two ears of the head casing (22). The fourth driving element (61) includes, as shown in FIG. 13, a fourth gear box (611) having therein a reduced gear set (613), a fourth motor (612) mounted outside the fourth gear box (611) for connection with an input end of the reduced gear set (613) and two output rods (614) respectively and operably connected to two ends of the reduced gear set (613) so as to connect to a corresponding one of the two ear-like plates (62) via a second linkage (621).

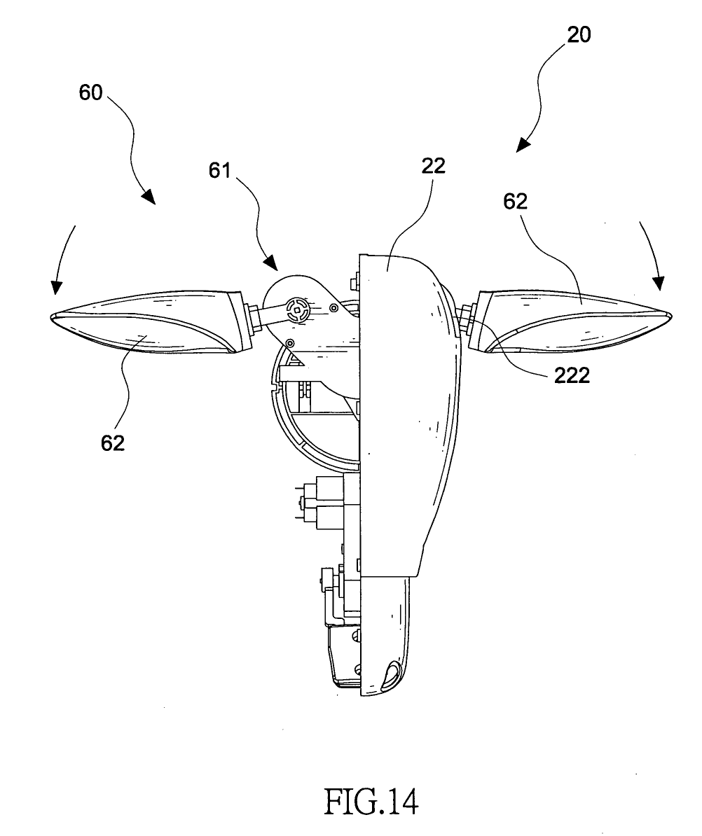

With reference to FIG. 14, when the fourth motor is activated, the reduced gear set (613) is able to drive the two output rods (614) to rotate, which drives the two ear-like plates (62) to move. The movement of the two ear-like plates (62) presents an ear moving effect to the observer.

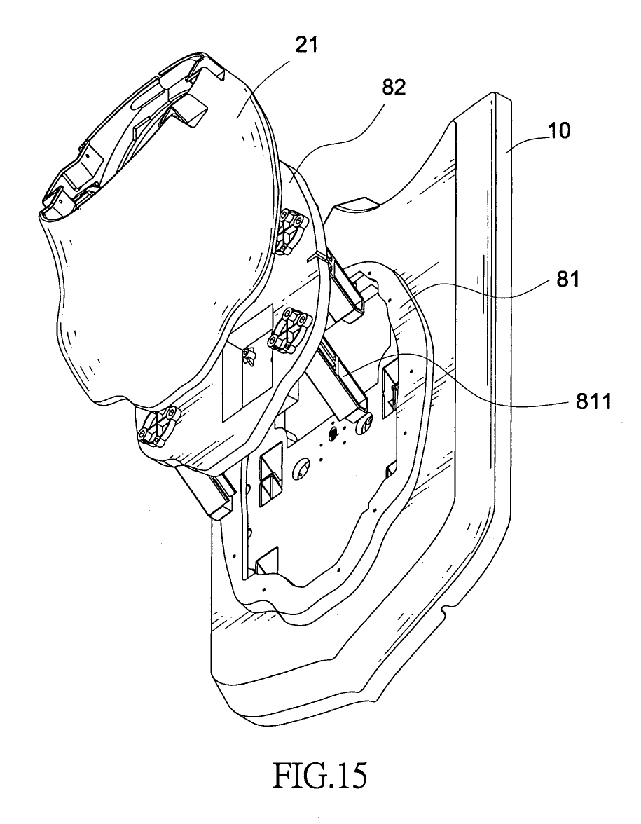

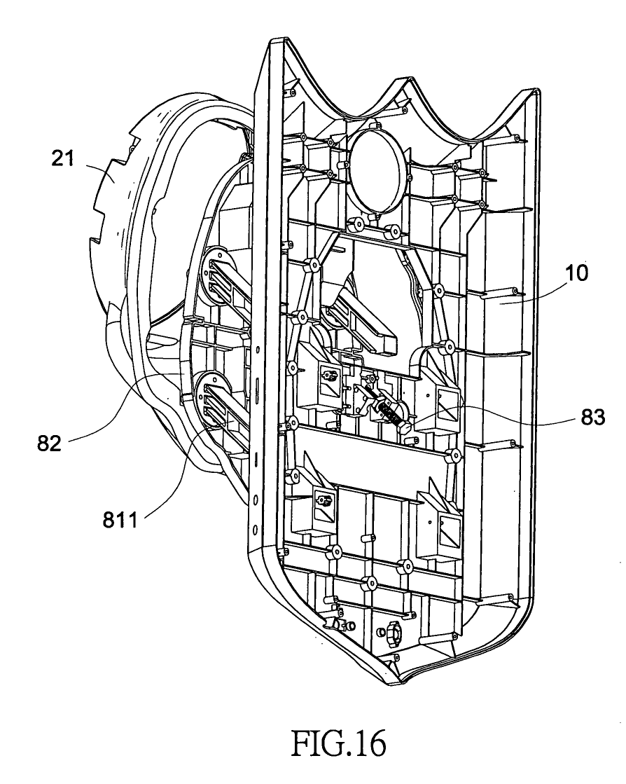

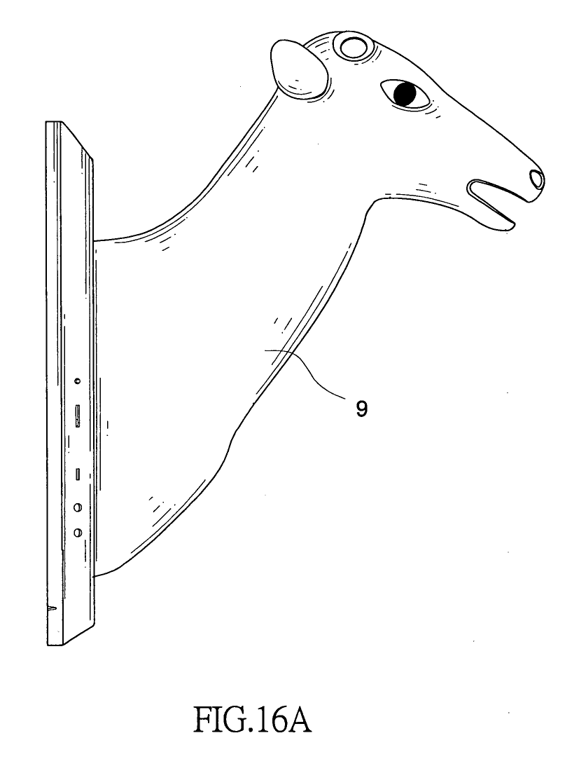

With reference to FIGS. 15 and 16, it is noted that a fixing plate (81) is firmly engaged with the base seat (10) and an adjustment plate (82) is securely connected to a bottom face of the enclosure (21) and has multiple openings defined through the adjustment plate (82) to allow extension of guiding rods (811) which are formed on the fixing plate (81) so that the adjustment plate (82) as well as the enclosure (21) is able to move along the guiding rods (811) relative to the base seat (10). Furthermore, an adjustment bolt (83) is threadingly extended through the base seat (10) and the fixing plate (81) to abut a bottom face of the adjustment plate (82) such that the user is able to adjust a distance of the adjustment plate (82) to the fixing plate (81) to adjust tightness of a cover (9) (as shown in FIG. 16A) which is provided to the head casing (22) and extended downward to enclose the enclosure (21) as a skin of the decoration (20) by rotating the adjustment bolt (83).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A motorized wall mount comprising:
a base seat for secure engagement with a wall surface;
an enclosure movably connected to the base seat so that a distance between the enclosure between the base seat and the enclosure is adjustable;
a hollow head casing spaced apart from and connected to the enclosure via loops therebetween and resilient elements in connection with the enclosure, the hollow head casing and each one of the loops such that a neck is formed between the enclosure and the hollow head casing;
an adjustment bolt threadingly extending through the base seat to abut a bottom face of the enclosure to adjust the distance between the enclosure and the base seat;
an elastic support extending from the base seat to connect to a first pivot plate which is pivotally connected to a second pivot plate, the second pivot plate being securely received in the hollow head casing such that the hollow head casing is able to pivot relative to the enclosure; and
a power supply device operably connected to the enclosure and the hollow head casing to drive the hollow head casing to pivot relative to the enclosure.

2. The motorized wall mount as claimed in claim 1 further having springs mounted between the first pivot plate and the second pivot plate to provide a recovery force to the hollow head casing after the hollow head casing is driven by the power supply device.

3. The motorized wall mount as claimed in claim 1, wherein the enclosure has a first opening defined in a front portion thereof, the hollow head casing has a second opening defined in a front portion thereof and two apertures respectively defined in two opposed sides thereof.

4. The motorized wall mount as claimed in claim 2, wherein multiple second springs are provided between the enclosure and the hollow head casing to provide a recovery force to the hollow head casing.

5. The motorized wall mount as claimed in claim 4, wherein the power supply device includes a first power supply mounted on a bottom face of the enclosure and having a first driving element and two cords respectively connected to two opposed sides of the hollow head casing such that the first driving element is able to drive the hollow head casing to move back and forth via the two cords.

6. The motorized wall mount as claimed in claim 5, wherein the first driving element is composed of a gear box, a motor mounted outside the gear box and a reeling wheel having therein two positioning holes corresponding to the two cords so as to receive therein two first ends of the two cords, two second ends of the two cords are respectively extended to a rear portion and a front portion of the hollow head casing so that activation of the motor is able to drive the two cords via the reeling wheel and the hollow head casing is able to move back and forth.

7. The motorized wall mount as claimed in claim 5, wherein the power supply device further has a second power supply mounted on the bottom face of the enclosure and above the first power supply, the second power supply includes a second driving element and two second cords respectively extended from the second driving element to a left side and a right side of the hollow head casing such that the second driving element is able to drive the hollow head casing to rock side to side via the two second cords.

8. The motorized wall mount as claimed in claim 7, wherein the second driving element includes a second gear box, a second motor mounted outside the gear box and a second reeling wheel having two second positioning holes to receive therein the two second cords such that activation of the second motor is able to alternatively drive the two second cords via the second reeling wheel and the hollow head casing is able to rock side to side.

9. The motorized wall mount as claimed in claim 6, wherein the power supply device further has a second power supply mounted on the bottom face of the enclosure and above the first power supply, the second power supply includes a second driving element and two second cords respectively extended from the second driving element to a left side and a right side of the hollow head casing such that the second driving element is able to drive the hollow head casing to rock side to side via the two second cords.

10. The motorized wall mount as claimed in claim 9, wherein the second driving element includes a second gear box, a second motor mounted outside the gear box and a second reeling wheel having two second positioning holes to receive therein the two second cords such that activation of the second motor is able to alternatively drive the two second cords via the second reeling wheel and the hollow head casing is able to rock side to side.

11. The motorized wall mount as claimed in claim 5, wherein the power supply device further has a third power supply mounted on a bottom face defining the second opening of the hollow head casing, the third power supply having a third driving element and a moving plate operably connected to the third driving element via a linkage so that the moving plate is controlled by the third driving element to move to present a mouth opening and closing effect.

12. The motorized wall mount as claimed in claim 11, wherein the third driving element includes a third gear box, a third motor mounted outside the third gear box and an axle extending out of the gear box to connect to the linkage such that activation of the third motor is able to drive the moving plate to move to present the mouth opening and closing effect.

13. The motorized wall mount as claimed in claim 10, wherein the power supply device further has a third power supply mounted on a bottom face defining the second opening of the hollow head casing, the third power supply having a third driving element and a moving plate operably connected to the third driving element via a linkage so that the moving plate is controlled by the third driving element to move to present a mouth opening and closing effect.

14. The motorized wall mount as claimed in claim 13, wherein the third driving element includes a third gear box, a third motor mounted outside the third gear box and an axle extending out of the gear box to connect to the linkage such that activation of the third motor is able to drive the moving plate to move to present the mouth opening and closing effect.

15. The motorized wall mount as claimed in claim 10, wherein the power supply device further has a fourth power supply provided inside the hollow head casing and having a fourth driving element mounted on a rear portion of the casing and two ear-like plates respectively extending out of the two apertures of the hollow head casing to function as two ears of the hollow head casing such that the fourth driving element is able to drive the two ear-like plates to move to present an ear moving effect, wherein the fourth driving element is composed of a fourth gear box, a fourth motor in connection with a reduced gear set received in the fourth gear box to initiate rotation of two output rods respectively and operably connected to two ends of the reduced gear set so as to connect to a corresponding one of the two ear-like plates via a second linkage.

16. The motorized wall mount as claimed in claim 11, wherein the power supply device further has a fourth power supply provided inside the hollow head casing and having a fourth driving element mounted on a rear portion of the casing and two ear-like plates respectively extending out of the two apertures of the hollow head casing to function as two ears of the hollow head casing such that the fourth driving element is able to drive the two ear-like plates to move to present an ear moving effect, wherein the fourth driving element is composed of a fourth gear box, a fourth motor in connection with a reduced gear set received in the fourth gear box to initiate rotation of two output rods respectively and operably connected to two ends of the reduced gear set so as to connect to a corresponding one of the two ear-like plates via a second linkage.

17. The motorized wall mount as claimed in claim 12, wherein the power supply device further has a fourth power supply provided inside the hollow head casing and having a fourth driving element mounted on a rear portion of the casing and two ear-like plates respectively extending out of the two apertures of the hollow head casing to function as two ears of the hollow head casing such that the fourth driving element is able to drive the two ear-like plates to move to present an ear moving effect, wherein the fourth driving element is composed of a fourth gear box, a fourth motor in connection with a reduced gear set received in the fourth gear box to initiate rotation of two output rods respectively and operably connected to two ends of the reduced gear set so as to connect to a corresponding one of the two ear-like plates via a second linkage.

18. The motorized wall mount as claimed in claim 13, wherein the power supply device further has a fourth power supply provided inside the hollow head casing and having a fourth driving element mounted on a rear portion of the casing and two ear-like plates respectively extending out of the two apertures of the hollow head casing to function as two ears of the hollow head casing such that the fourth driving element is able to drive the two ear-like plates to move to present an ear moving effect, wherein the fourth driving element is composed of a fourth gear box, a fourth motor in connection with a reduced gear set received in the fourth gear box to initiate rotation of two output rods respectively and operably connected to two ends of the reduced gear set so as to connect to a corresponding one of the two ear-like plates via a second linkage.

19. The motorized wall mount as claimed in claim 14, wherein the power supply device further has a fourth power supply provided inside the hollow head casing and having a fourth driving element mounted on a rear portion of the casing and two ear-like plates respectively extending out of the two apertures of the hollow head casing to function as two ears of the hollow head casing such that the fourth driving element is able to drive the two ear-like plates to move to present an ear moving effect, wherein the fourth driving element is composed of a fourth gear box, a fourth motor in connection with a reduced gear set received in the fourth gear box to initiate rotation of two output rods respectively and operably connected to two ends of the reduced gear set so as to connect to a corresponding one of the two ear-like plates via a second linkage.
